(19) United States
(12) Patent Application Publication
(10) Pub. No.: US 2008/0136154 A1
(43) Pub. Date: Jun. 12, 2008

(54) Airbag Inflator Gas Outlet and a Method of Manufacturing an Airbag Inflator

(75) Inventors: Johan Lindqvist, Alingsas (SE); Ulf Magnusson, Alingsas (SE); Roland Schneider, Haar (DE); Stefan Svedjenas, Alingsas (SE); Alf Holgers, Alingsas (SE); Ulrich Sander, Karlsfeld (DE)

Correspondence Address: HARNESS, DICKEY & PIERCE, P.L.C., P.O. BOX 828, BLOOMFIELD HILLS, MI, 48303, US

(73) Assignee: Autoliv Development AB, Vargarda (SE)

(21) Appl. No.: 11/795,345

(22) PCT Filed: Feb. 15, 2005
(86) PCT No.: PCT/SE05/00206

§ 371 Date: Oct. 17, 2007

(51) Int. Cl. B60R 21/26; B23P 15/00

(52) U.S. Cl. 280/741; 29/890.09

(57) ABSTRACT

An airbag inflator (1) for motor vehicles, more specifically an airbag inflator which is adapted to reduce high sound levels generated by the streaming of a gas flow out of the outlet into ambient air, which airbag inflator comprises at least one gas outlet (9) which is adapted to reduce high sound level generated by the streaming of a gas flow out of the outlet into ambient air. The gas outlet (9) of the airbag inflator (1) has an orifice (10;18) that is non-circular. When in use, the non-circular orifice (10; 18) of the gas outlet (9) enhances the mixing of the gas flow with the ambient air and thus provides for a reduction of the sound level caused by the gas flow.

### TECHNICAL AREA

The present invention relates to airbag inflators and more in particular to airbag inflators having gas outlets arranged to reduce sound caused by streaming fluid.

### TECHNICAL BACKGROUND

It is today well known to use airbags in motor vehicles in order to protect the occupants of the vehicle in the case that an accident occurs. Typically the airbag is connected to a gas generator which, in the event of an accident and in response to an appropriate signal, quickly fills with fluid, typically gas, aerosol or foam.

The gas flow rate has to be very high in order to fill the airbag before the occupant collides with it. As a consequence of the gas flow rate high sound levels are generated. The peak values can be higher than 120 dB. These sound levels can be harmful for an occupant of the vehicle, especially if many gas generators are activated at the same time.

The sound is generated as a result of the velocity difference between the streaming gas and the ambient air, which is at rest. When the gases flow from a combustion chamber through a conventional circular gas nozzle into an airbag cushion, the motion of the streaming gas creates shear forces between the gas flow and the ambient air which in turn leads to shock waves and high sounds.

From U.S. Pat. No. 3,807,755 it is known to have a manifold that includes a converging-diverging nozzle that receives a streaming gas from a gas generator. The converging-diverging nozzle has a throat which provides for the creating of a shock wave. The converging-diverging nozzle continues with a passage portion until it reaches a converging nozzle. This second nozzle inhibits the movement of the shock wave, which then is trapped in the passage portion. By controlling the location of the shock wave with respect to the flow outlet to the cushion, the arrangement reduces the noise level.

The arrangement suggested in U.S. Pat. No. 3,807,755 does however constitute a complicated way to attend to the problems with high sound levels. The need for at least two nozzles with an elongated passage portion in-between means that the occupant restraint system will be more heavy, bulky and eventually also more expensive than conventional airbag inflators.

### SUMMARY OF THE INVENTION

An object of the present invention is to provide an improved airbag inflator which eliminates at least some of the above problems.

According to the present invention this and other objects are achieved with an airbag inflator for motor vehicles, which inflator has at least one gas outlet which is adapted to reduce high sound levels generated by the streaming of a gas flow out of the outlet into ambient air, wherein the orifice of the gas outlet is non-circular.

The present invention is based on the understanding that increasing the circumference of the orifice of a gas outlet can reduce the sound level of an airbag inflator.

In this way the contact area between the gas flow and the ambient air is increased and as a consequence, a reduction of the shear forces between the gas flow and the ambient air, as well as of the sound level, is achieved.

The orifice of said gas outlet can have tapered sections. By providing the gas outlet in this way a variety of orifice shapes can be used, for example a square shape or any other polygonal shape. However, the shape does not necessarily need to have pointed edges, also elliptical shapes can be used. Orifices with these type of shapes are easily manufactured, and are sometimes even available as standardized components.

Preferably the orifice of said gas outlet is star shaped. By using a star shaped orifice, the contact area between the gas flowing out of the gas outlet and the ambient air can be increased further. The contact area and the decrease in sound level depends on the number and size of the points of the star; a star shaped orifice having many points and wherein the points have large extension will exhibit an increased contact area in comparison with a star shaped orifice with few and short points.

According to an embodiment of the invention, the upstream inner cross-section of said gas outlet differs in shape from a downstream inner cross-section of said gas outlet. By providing the gas outlet in this way, a gas outlet which changes the shape of the gas flowing through it, is achieved. The change can appear well inside the gas outlet or precisely before the orifice. By providing a gradual change of the cross-section, also the gas flow is changed gradually, which produces less turbulence and a lower sound level can thereby be achieved. As an example of such a change, the upstream inner cross-sections can have a circular shape, which, in the direction of the orifice, gradually changes to a star shape.

Further, the shape of an upstream inner cross-section of said gas outlet can exhibit a rotational difference from the shape of a downstream inner cross-section of said gas outlet. Such a rotational difference can be caused by the rotating of a non-circular inner cross-section in the direction of the longitudinal extension of the gas outlet, for example caused by a twisting of the gas outlet around its longitudinal extension. Such a shape would cause a gas flowing out of the gas outlet to exhibit a spiral movement inside the gas outlet, and when reaching the orifice, this spiral movement would facilitate the mixing of the gas flow with the ambient air, thus further increasing the contact area and decreasing the sound level.

Preferably, the orifice of said gas outlet has lobe-shaped sections. By providing the orifice with lobe-shaped sections, it will also be easy to achieve a gradually changing inner cross-section of the gas outlet. In fact, both features can be achieved by applying alternately appearing indentations and extensions around the circumference of the gas outlet. Due to the plastically deforming properties of the material constituting the gas outlet, the indentations and the extensions will have a gradual character which makes them stretch upstream thereby changing an upstream inner cross-section of the gas outlet as well as the orifice circumference. It should be noted that the extensions can be stretched beyond the upstream outer diameter of the gas outlet in order to ensure that the cross-sectional area of the orifice is maintained, or at least only reduced to a limited degree.

According to an embodiment of the invention said inflator has a cylindrical shape and is provided with a series of radially directed gas outlets on its lateral area. By providing a series of gas outlets in this way, an even and efficient inflation of an associated airbag cushion will result. In order to adapt the inflation to the desired form of the airbag cushion, the gas outlets can be differently shaped and unevenly distributed around the airbag inflator.

According to another aspect of the invention there is provided a method of manufacturing an airbag inflator for motor vehicles, which inflator has at least one gas outlet which is adapted to reduce high sound levels generated by the streaming of a gas flow out of the outlet into ambient air, comprising the steps of providing an airbag inflator body; adapting the inflator body in order to achieve at least one gas outlet having a non-circular orifice. This method constitutes a convenient method of manufacturing an airbag inflator, and essentially the same advantages as mentioned above are achieved also by this aspect of the invention.

The invention is applicable with all sorts of airbag cushions, and it is of special relevance to such airbags that are arranged in physical proximity to humans. Other objects and advantages will be apparent to those skilled in the art from the following detailed description taken in conjunction with the appended claims and drawings.

### BRIEF DESCRIPTION OF THE DRAWINGS

The present invention will now be described in more detail with reference to the accompanying schematic drawings which show preferred embodiments of the invention and in which:

FIG. 1 shows a perspective view of an airbag inflator according to an embodiment of the invention;

FIG. 2 shows a perspective view of an embodiment of an orifice part to be used with an embodiment of the invention;

FIG. 3 shows a perspective view of another embodiment of an orifice part to be used with an embodiment of the invention;

FIG. 4 shows a perspective view of another embodiment of an orifice part to be used with an embodiment of the invention; and

FIG. 5 shows a perspective view of an embodiment of a wrinkled gas outlet according to an embodiment of the invention.

### DETAILED DESCRIPTION OF THE INVENTION

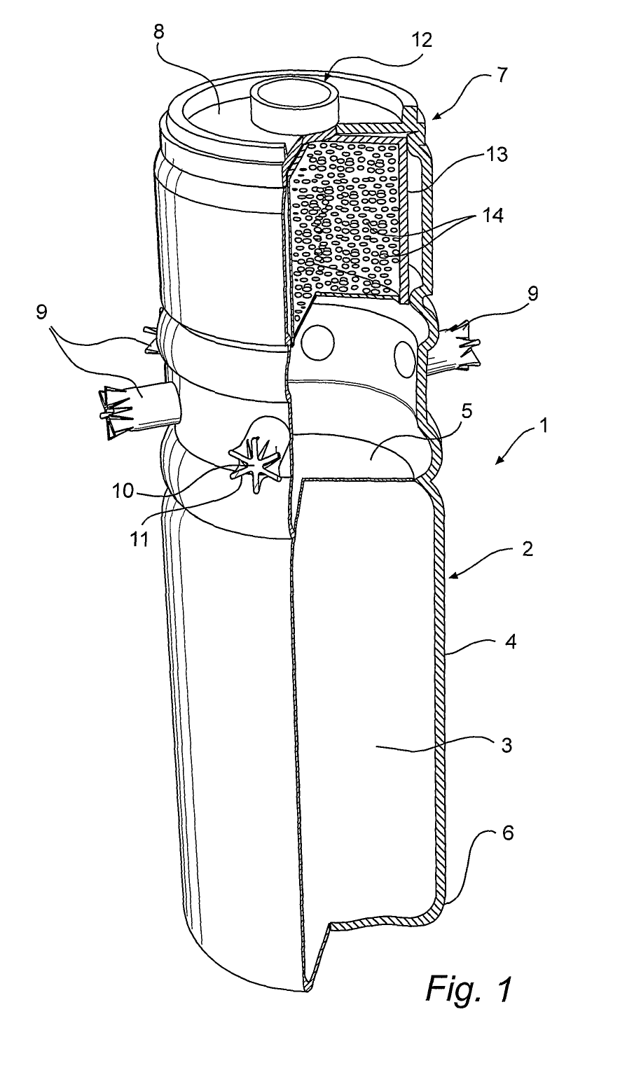

With initial reference to FIG. 1, there is shown a perspective view of an airbag inflator 1, according to an embodiment of the invention. The airbag inflator 1, which preferably is made of metal, has a storage chamber 2 that is filled and pressurized with contents, designated by the reference numeral 3. In accordance with a preferred embodiment of the invention, the chamber contents 3 comprise a supply of gas. Such compressed gases can be stored in gaseous or liquid form, or as a mixture of gas and liquid.

The storage chamber 2 is defined by an elongated generally cylindrical sleeve 4, preferably in the form of a seamless tube. Oppositely arranged to each other, the sleeve 4 have an inner wall end 5 and a sleeve end closure 6. A gas mixing chamber 7 in the general form of a tube is on one side formed or appropriately joined or attached to the inner wall end 5 and has on its other side a chamber end closure 8. The sleeve end closure 6 may comprise a fill port (not shown in the drawings) through which chamber contents 3 can be filled into the storage chamber 2. When the storage chamber 2 has been filled such a fill port can be plugged or blocked.

Next to the inner wall end 5 the mixing chamber 7 has a series of gas outlets 9 on its side wall, which gas outlets 9 in this embodiment of the invention are evenly circumferentially spaced on the circumference of the gas mixing chamber 7. As with the storage chamber 2 and the gas mixing chamber 7, the gas outlets 9 are preferably made of metal. Each gas outlet 9 has an orifice 10 on its end surface 11, where through, in the case of an accident, the inflation gas from the inflator 1, and particularly the gas mixing chamber 7, is dispensed into an associated airbag cushion (not shown in the drawings). The orifices 10 are star-shaped. An upstream inner cross-section of a gas outlet 9 can have the same shape as the orifice 10, but the gas outlets 9 can also be provided with a differing inner cross-section. As will be appreciated by those skilled in the art, the number and positioning of the gas outlets 9 can be selected to provide a desired particular inflation performance in a certain inflator installation.

An initiator device 12 is arranged on the chamber end closure 8 of the gas mixing chamber 7 which further contains a combustion chamber 13. The combustion chamber 13 contains a supply of a selected gas generant reactant material 14, for example in the form of pellets, wafers or grains. The combustion chamber 13 separates the reactant material 14 from the storage chamber 2 and may advantageously be situated adjacent to the chamber end closure 8 and particularly adjacent to the initiator device 12.

As described in greater detail below, the gas generant material 14 is reactable to form reaction products effective to break the combustion chamber 13 and the inner wall end 5 of the gas storage chamber 2, and upon fluid communication with the chamber contents 3 of the storage chamber 2, result in a mixture of hot and cold gas which flows through the gas outlets 9 and into the associated airbag.

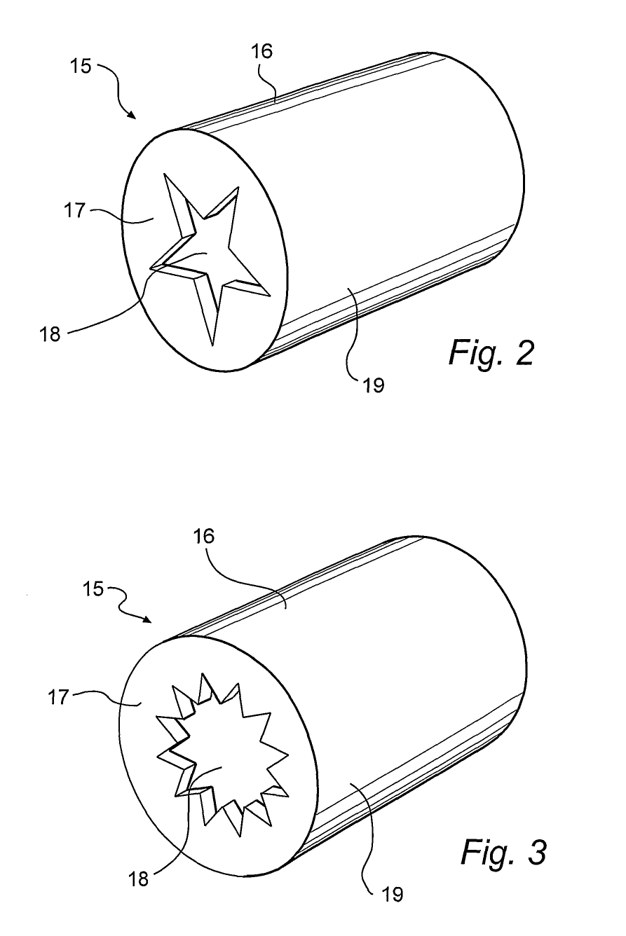

FIG. 2 shows a perspective view of an embodiment of an orifice part 15 to be used with an embodiment of the invention. The orifice part 15 is constituted by a sheet 16, which preferably is made of metal and comprises a planar front sheet part 17, which is provided with a orifice 18 having a non-circular shape, in the form of a 5-pointed star, and a side sheet part 19, which extends in a different angular direction in comparison with the planar front sheet part 17. The orifice 18 can for example be achieved by means of stamping or cutting. The sheet is adapted to have such form and size that the front sheet part 17 covers the respective end surface 11 of a gas outlet 9 of the airbag inflator 1. In this way the orifice part 15 is adapted to be arranged over a gas outlet 9 whereby its side sheet part 19 can be fastened, for example by means of welding or clamping, to the lateral area of the gas outlet 9. By in this way arranging an orifice part 15 to an arbitrary gas outlet of a conventional airbag inflator, said gas outlet is provided with an orifice 18 having the non-circular shape of the orifice part 15.

FIG. 3 shows a perspective view of an embodiment of an orifice part 15 to be used with an embodiment of the invention. The orifice part 15 has a orifice 18 with an alternative shape, in the form of a 16-pointed star.

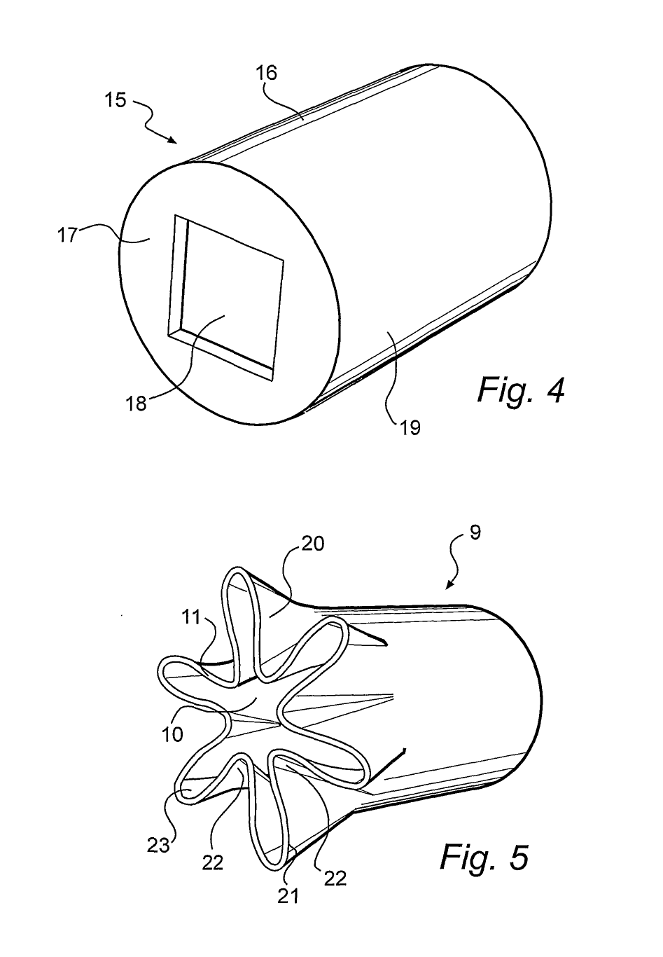

FIG. 4 shows a perspective view of an embodiment of an orifice part 15 to be used with an embodiment of the invention. The orifice part 15 has a orifice 18 with an alternative shape, in the form of a square. It should be noted that also orifices 10 of gas outlets 9 can be provided with the shapes of the orifices 18 shown in FIG. 2-4.

FIG. 5 shows a perspective view of an embodiment of a gas outlet 9 of a gas mixing chamber 7 (not shown) to be applied with an airbag inflator according to an embodiment of the invention. At its outer end 20, facing away from the gas mixing chamber 7 (not shown), the gas outlet 9 is provided with a series of radially outwards directed extensions 21 and a series of radially inwards directed indentations 22. Both the extensions 21 and the indentations 22 are elongated along a certain length of the gas outlet 9, thereby providing for a gradual change of the cross-section of the gas outlet 9. The radially outwards directed extensions 21 and the radially inwards directed indentations 22 appear alternately along the circumference of the gas outlet 9, so as to provide the gas outlet 9 with an orifice 10 that has lobe shaped sections 23. The outwards directed extensions 21 cause the outer diameter to be larger at the outer end 20 of the gas outlet 9 than the outer diameter further upstream (in the direction of the gas mixing chamber 7). This ensures that the cross-sectional area of the orifice 10 is maintained, or at least only decreased to a limited degree. Consequently, when in use, the pressure of the gas flowing out of the gas outlet 9 will be maintained, or only increased to a limited degree. However, in certain applications of the invention, for example due to a desire to keep the volume of the airbag inflator limited, the gas outlet can be provided with extensions 21 not extending beyond an outer diameter further upstream, thereby ensuring a constant outer diameter of the gas outlet 9. The adapting of the gas outlet 9 shown in FIG. 5 can be achieved by machining the gas outlets 9 into a desired shape, for example by means of plastically wrinkling and stretching the material of the gas outlets 9. It should be noted that also an orifice part 15, for arrangement over an arbitrary gas outlet of a conventional airbag inflator, can be provided with extensions 21 and indentations 22 in resemblance with the gas outlet 9 of FIG. 5.

In the following a typical function of an airbag inflator 1 according to the invention is described in more detail.

Upon sensing a collision involving the vehicle, an electrical signal is sent from a sensor (not shown) and received by the initiator device 12. The initiator device 12 ignites at least a part of the gas generant material 14 in the combustion chamber 13, and as a consequence of this combustion heat and gaseous reaction products are produced. The reaction increases the pressure in the combustion chamber 13 which ruptures and breaks or otherwise opens the inner wall end 5 of the storage chamber 2. This allows the unheated but pressurized gaseous chamber contents 3 of the storage chamber 2 to pass into the gas mixing chamber 7 and mix with the hot product gases from the combustion chamber 13. Then the gas mixture enters into the gas outlets 9 and inflates the associated airbag cushion.

Due to the non-circular shape of the orifices 10 or 18 of the respective gas outlets 9 the gas flow has a large contact area to the ambient air when flowing out through the orifices 10 or 18. In comparison with gas outlets having circular orifices, the orifices 10 or 18 of the present invention produce a significant decrease in the shear forces between the gas flow and the ambient air, which in turn produce a corresponding effective braking of the flow and a decrease of the noise level. This increased braking effect of the ambient air is caused not only by the increased contact area of the gas flow, but also of the gas flow being converted into separate, smaller sections. As a result, a larger extent of the particles in the gas flow is exposed to and braked by the ambient air. This braking allows for the ambient air to be in contact with the inner particles of the gas flow, which then at an earlier point in time, in comparison with a gas flow with circular cross-section, is exposed to the braking effect of the ambient air.

It should be noted that different modifications of the embodiments of the invention described above are feasible within the scope of the invention, as it is defined by the following claims. For example it is possible to use other material than metals, such as ceramic or composite material, to produce the gas outlets 10 and the other parts of the airbag inflator 1. Further, other non-circle shapes of the orifices of the gas outlets 10, such as for example a triangular shape, are within the scope of the invention.

It should also be noted that other constructions for generating a gas flow could be used, for example a storage chamber containing compressed gases which, in case of an accident opens by an opening mechanism (pyrotechnic or non-pyrotechnic) to allow a gas flow into the airbag cushion. Further examples are pyrotechnic inflators, only using pyrotechnics to generate the gas flow, or inflators using reactive gases or liquids, such as hydrogen and oxygen stored separately in two chambers or premixed in one chamber, combusted in a combustion chamber before entering the airbag or combusted in the airbag after entering the airbag. It is also possible to combine different gas generating constructions.

1-11. (canceled)

12. An airbag inflator for motor vehicles, the air bag inflator comprising:
at least one gas outlet adapted to reduce high sound levels generated by the streaming of a gas flow out of the outlet into ambient air, the at least one gas outlet having a non-circular orifice.

13. The airbag inflator according to claim 12, wherein the orifice of the gas outlet has tapered sections.

14. The airbag inflator according to claim 12, wherein the orifice of the gas outlet is star shaped.

15. The airbag inflator according to claim 12, wherein an upstream inner cross-section of the gas outlet differs in shape from a downstream inner cross-section of the gas outlet.

16. The airbag inflator according to claim 12, wherein an upstream inner cross-section of the gas outlet has a shape that exhibits a rotational difference from a shape of a downstream inner cross-section of the gas outlet.

17. The airbag inflator according to claim 12, wherein the orifice of the gas outlet has lobe-shaped sections.

18. The airbag inflator according to claim 12, wherein the inflator has a cylindrical shape and is provided with a series of radially directed gas outlets on a lateral area.

19. A method of manufacturing an airbag inflator for motor vehicles, the inflator having at least one gas outlet which to reduce high sound levels generated by the streaming of a gas flow out of the outlet into ambient air, the method comprising:
providing an airbag inflator body; and
adapting the inflator body in order to achieve at least one gas outlet having a non-circular orifice.

20. The method of manufacturing an airbag inflator for motor vehicles according to claim 19, wherein the step of adapting the inflator body further comprises the step of, for each gas outlet, machining the gas outlet in order to provide the gas outlet with a non-circular orifice.

21. The method of manufacturing an airbag inflator for motor vehicles according to claim 20, wherein machining the gas outlet further comprises wrinkling the gas outlet in order to provide the gas outlet with an orifice having lobe-shaped sections.

22. The method of manufacturing an airbag inflator for motor vehicles according to claim 19, wherein adapting the inflator body further comprises, for each gas outlet:
providing an orifice part having a non-circular orifice; and
attaching the orifice part to the gas outlet.
